(19) United States
(12) Patent Application Publication
(10) Pub. No.: US 2008/0251681 A1
(43) Pub. Date: Oct. 16, 2008

(54) Mounting Assembly For Stable Attachment of a Seat, Particularly a Bicycle Saddle

(75) Inventor: Stefano Segato, Vicenza (IT)

Correspondence Address: Themis Intellectual Property Counsel, 7660 Fay Ave Ste H535, La Jolla, CA, 92037, US

(73) Assignee: SELLE ROYAL S.p.A.., Pozzoleone (IT)

(21) Appl. No.: 12/094,153

(22) PCT Filed: Dec. 1, 2006
(86) PCT No.: PCT/IB06/54555

§ 371 Date: May 17, 2008

(30) Foreign Application Priority Data
Dec. 2, 2005 (IT) VI2005A000322

(51) Int. Cl. A47B 97/00; B62J 1/18

(52) U.S. Cl. 248/503.1; 297/214

(57) ABSTRACT

The present invention finds application in the field of support structures and particularly relates to a mounting assembly for stable attachment of a seat (3) having a stiffening shell (2) to a movable or stationary support frame. The assembly comprises a bracket (4), which is substantially symmetric with respect to a substantially vertical longitudinal plane (π) and is formed of a pair of side rods (5′, 5″) having front end portions (6′, 6″) and rear end portions (7′, 7″) designed for connection to the front part (8) and the rear part (9) of the shell (2) respectively. The rear end portions (7′, 7″) have a widened shape defining respective male anti-rotation members (10′, 10″) which are designed to be longitudinally slid into respective complementary first female receptacles (11′, 11″) rigidly associated to the shell (2).

### FIELD OF THE INVENTION

The present invention finds application in the field of support structures and particularly relates to a mounting assembly for stable attachment of a seat to a movable or stationary support frame.

The invention further relates to a bracket for forming such assembly and a seat comprising such assembly.

### BACKGROUND OF THE INVENTION

The connection of a human body seating support structure to a frame, such as a saddle to be mounted to a bicycle, a chair or a vehicle seat, has to be as stable as possible, and prevent any relative motion between the seat and the means for attachment thereof to the support frame, which would affect user comfort.

In most common-use solutions, such connection utilizes special support frames or brackets interposed between the seat proper and the bicycle frame.

For example, in a bicycle saddle, the seating element is generally composed of an upper body, with a pad therein, connected to a rigid lower shell.

Such shell has a predetermined number of receptacles for connection with the support bracket, commonly known as rails, which is designed to interact with the various fastening means connected to the seat post or directly to the bicycle frame.

The bracket is typically composed of a pair of cylindrical rods made of metal or another material selected, for example, from composite materials of adequate mechanical strength, in parallel arrangement beneath the saddle shell.

The rails are connected to the saddle by fitting the ends of each rod in respective shell receptacles, whose shape is substantially complementary to that of their respective rod ends, to provide an accurate and stable male/female fit.

In common solutions, the rail rods substantially have the shape of substantially circular cylinders and their connection with the respective shell receptacles is only ensured by retention of the outer surfaces of the latter.

This does not provide a sufficiently stable connection, as the saddle frame rods can rotate within their receptacles, with a twisting motion, thereby causing receptacle damage and disconnection between the saddle and the bracket.

In an attempt to obviate the above drawbacks, a variety of solutions have been envisaged, providing brackets for saddles or human body seating structures, having a more stable connection with the support frame.

US2004/0145222 discloses a bicycle saddle having a saddle frame for support and connection to the bicycle frame, whose rods have respective rear ends bent into open-ring shapes and a common front end, which is also bent.

The latter is attached to the saddle shell by fitting into a receptacle consisting of a removable cover that is fixed to the shell by screws, whereas the lower ends are snap engaged around lower shock-absorbing elements.

Therefore, this solution provides connection between the bracket and the shell by interposing several different intermediate elements therebetween, which makes such connection quite laborious and does not ensure adequate seating stability, due to the unavoidable clearances generated between these elements and the bracket.

### SUMMARY OF THE INVENTION

The object of this invention is to overcome the above drawbacks, by providing a mounting assembly for stable attachment of a seat that is highly efficient and relatively cost-effective.

A particular object is to provide a mounting assembly that prevents any relative rotation between the frame connection bracket and the seat support shell, to stabilize the connection of the whole seat to the support frame.

A further object is to provide a mounting assembly that allows easy and quick connection between the bracket and the seat.

Yet another object of the invention is to provide a bracket for use with a seat, i.e. a bicycle saddle, which prevents any rotation about a longitudinal axis with respect to the seat shell, thereby providing a highly stable and comfortable connection.

Another important object of the present invention is to provide a seat that has a high aesthetic quality.

These and other objects as better explained hereafter, are fulfilled by a mounting assembly for stable attachment of a seat having a stiffening shell, i.e. a bicycle saddle, to a movable or stationary support frame, as defined in claim 1, which comprises a bracket that is substantially symmetric with respect to a substantially vertical longitudinal plane, said bracket being composed of a pair of side rods, having front end portions and rear end portions designed to be connected to the front part and the rear part of the shell respectively.

The invention is characterized in that the rear end portions of the rods have a widened shape defining male anti-rotation members which are designed to be longitudinally slid into respective complementary first female receptacles rigidly associated to the shell.

Thanks to this particular configuration, the invention provides a mounting assembly that can prevent any relative rotation between the bracket and the shell about a longitudinal axis, thereby stabilizing connection thereof to the support frame.

Also, the widened rear end portions may be formed of respective curved end sections lying on predetermined development planes.

Conveniently, the first female receptacles may be elongate longitudinal cavities in substantially prismatic elements having at least one open front end for receiving respective male anti-rotation members sliding therein.

Thanks to this particular configuration, the male members of the bracket may be coupled to respective female receptacles associated to the shell in a very simple and quick manner.

In a further aspect, the invention provides a bracket as defined in claim 15, for use in a mounting assembly, which comprises two side rods having front end portions and rear end portions for connection to the front part and the rear part of a seat support shell respectively, wherein the rear end portions of the rods have a widened shape defining a male anti-rotation member, which is designed to longitudinally slide into respective complementary first female receptacles rigidly associated to the shell.

Thanks to this additional feature of the invention, any relative rotation between the bracket and the shell about a longitudinal axis will be prevented, and a stable and comfortable connection may be achieved.

In a third aspect, the invention provides a human body support seat as defined in claim 16, which comprises a resilient upper layer designed to elastically support a user's weight; a stiffening shell connected to the underside of the upper layer, a lower bracket, to be connected to a support frame, having a pair of side rods with front portions designed to be connected to the front of the shell and rear end portions designed to be connected to the rear part of the shell.

The seat is characterized in that the rear end portions of the rods have a widened shape to define male anti-rotation members which are designed to be longitudinally slid into respective complementary first female receptacles rigidly associated to the shell, so as to prevent any relative rotation between said bracket and said shell about a longitudinal axis.

This additional feature of the invention provides a highly stable and comfortable seat, which further has a high aesthetic quality.

### BRIEF DESCRIPTION OF THE DRAWINGS

Further features and advantages of the invention will be more apparent from the detailed description of a preferred, non-exclusive embodiment of a quick mount assembly, a bracket and a seat according to the invention, which are described as a non-limiting example with the help of the annexed drawings, in which:

FIG. 1 is a perspective view of a particular embodiment of a quick mount assembly according to the invention;

FIG. 2 is a front view of the assembly of FIG. 1;

FIG. 3 is an enlarged view of a detail of FIG. 1;

FIG. 4 is a top front view of a bracket according to the invention;

FIG. 5 is a perspective side view of the bracket of FIG. 3;

FIG. 6 is a rear front side view of the bracket of FIG. 3;

FIG. 7 is a bottom perspective, partly exploded view of a seat according to the invention.

### DETAILED DESCRIPTION OF A PREFERRED EMBODIMENT

Referring to the figures, the assembly of the invention, which is generally designated by numeral 1, may be used in bicycle saddles, chairs, vehicle seats and in any human body support seat, to facilitate stable attachment thereof to a support frame and enhance seat stability and comfort.

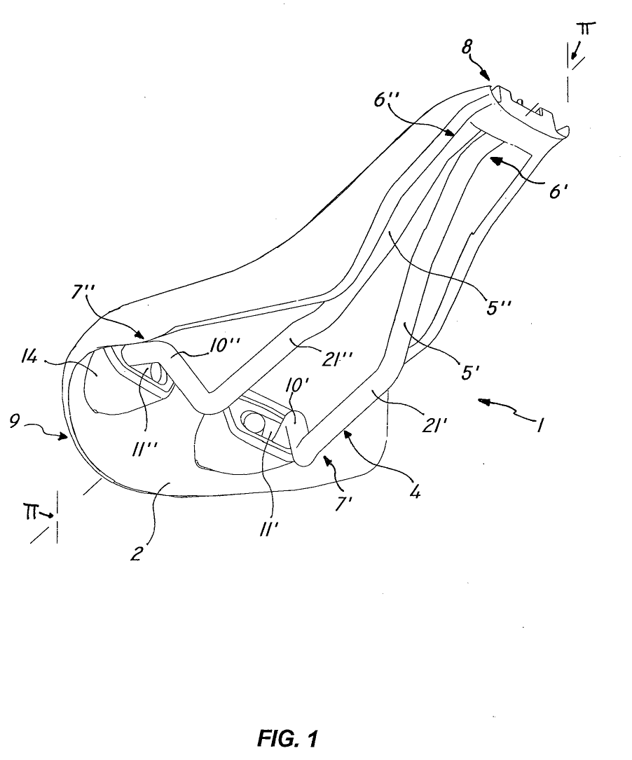

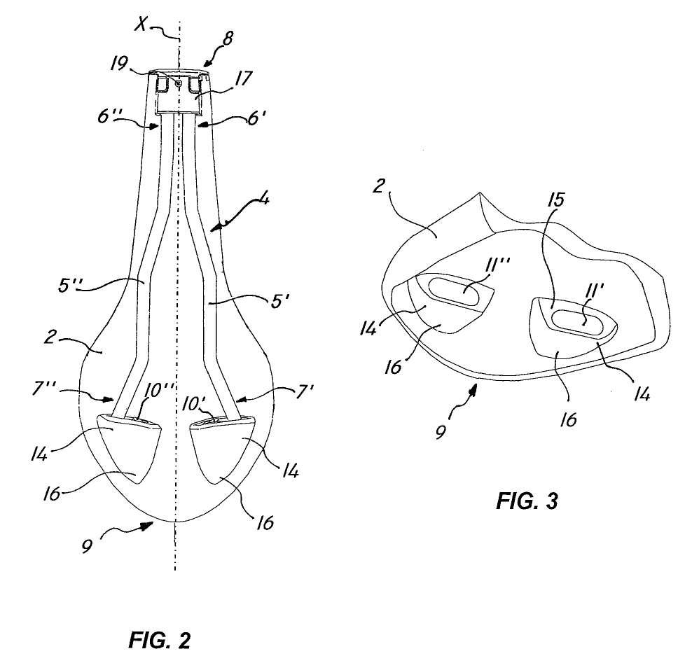

As shown in FIG. 1, the mounting assembly 1 is connected to a stiffening shell 2, to be associated to a bicycle saddle 3 for attachment thereof to a movable or stationary frame, not shown.

The assembly comprises a bracket 4, which is substantially symmetric with respect to a substantially vertical median longitudinal plane π and is formed of a pair of side rods 5′, 5″ having front end portions 6′, 6″ and rear end portions 7′, 7″ designed for connection to the front part 8 and the rear part 9 of the shell 2.

The bracket 4 may be made of any metal or metal alloy or of another material selected from the group of composite materials of adequate mechanical strength, to be able to withstand the stresses deriving from normal use of the seat 3.

The shell 2 is made from a material selected from plastic, composite, metal materials or the like and shall have adequate stiffness and mechanical strength to support a user's weight.

A peculiar feature of the assembly 1 of the invention is that the rear end portions 7′, 7″ of the rods 5′, 5″ have a widened shape, each defining a male anti-rotation member 10′, 10″, which is designed to be longitudinally slid into a respective complementary first female receptacle 11′, 11″ rigidly associated to the shell 2, so as to prevent any relative rotation between the bracket 4 and the shell 2 about a longitudinal axis X, and to stabilize connection to the support frame.

Preferably, the widened rear end portions 7′, 7″ are formed of respective curved end sections 12′, 12″ lying on predetermined development planes π′, π″.

In the particular illustrated embodiment, the development planes π′, π″ may be symmetrically inclined with respect to the longitudinal plane of symmetry π.

In an alternative embodiment, not shown, the development planes π′, π″ of the rear end portions 7′, 7″ may be substantially parallel and coincident.

Conveniently, the angle of curvature α of the end sections 12′, 12″ is of 10° to 180°. Preferred values of such angle α are of 90° to 170°.

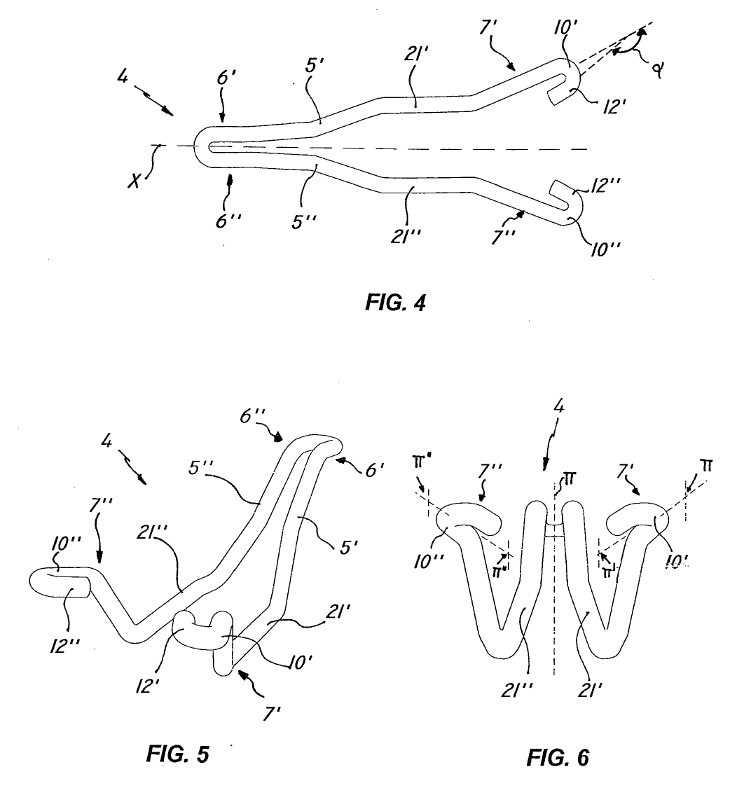

Therefore, the end sections 12′, 12″ may have a substantially U-shape in plan view, as particularly shown in FIGS. 4 to 6.

Thanks to this particular configuration of the end sections 12′, 12″ of the bracket 4, upon connection thereof with respective first female receptacles 11′, 11″, there will be at least two contact points with the shell 2, whose centers of rotation are not coincident, whereby the number of degrees of freedom for the rotation of the assembly 1 with respect to the seat 3 on which it is mounted is reduced.

As particularly shown in FIG. 3, the first female receptacles 11′, 11″ are elongate longitudinal cavities formed in substantially prismatic elements 14 having one open front end 15 for receiving respective male anti-rotation members 10′, 10″ sliding therein.

According to the illustrated embodiment, the prismatic elements 14 taper towards the rear end 16 and are rigidly and monolithically secured to the shell 2.

The prismatic elements 14 may be formed of the same material as the shell 2 or in any other material that can afford the required mechanical strength properties.

In an alternative configuration, not shown, the receptacles 11′, 11″ may be associated to the shell 2 by suitable external connection means, such as snap fit means, nut and screw assemblies or the like.

FIGS. 4 to 6 show a particular embodiment of a bracket 4 of the invention, for forming a quick mount assembly 1, whose rods 5′, 5″ have a substantially constant circular cross section.

The rods 5′, 5″ are appropriately shaped and joined at their front end portions 6′, 6″.

Particularly, the latter may be formed of one piece to allow insertion thereof into a single complementary second female receptacle 17, which is associated to the shell 2 at its front part 8.

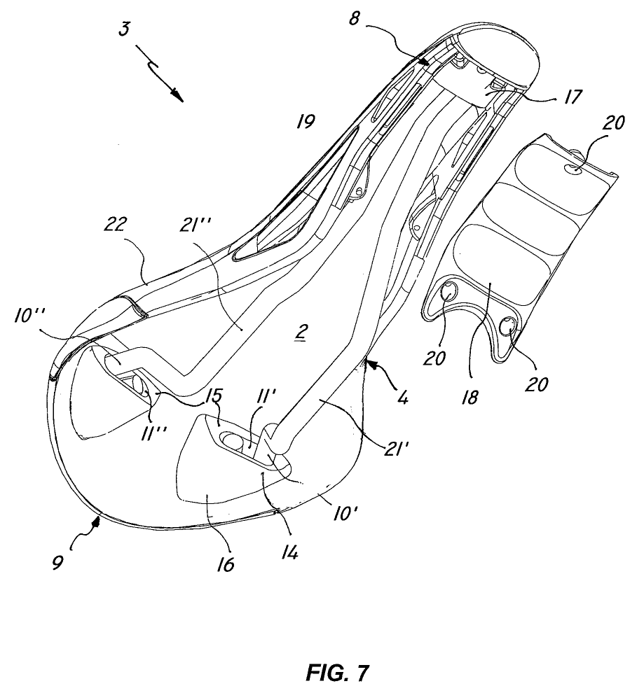

As shown in FIG. 7, the second female receptacle 17 may be covered by a movable element 18, which may be connected to the front part 8 of the shell 2 by suitable fastener means, not shown.

These means may be, for instance, screws or pins to be fitted into respective connection cavities 19 formed in the shell 2 through one or more through holes 20 aligned with such cavities 19 and formed in the movable element 18.

This will provide enhanced aerodynamics, as well as improved aesthetics to the whole seat 3.

The rods 5′, 5″ further have central portions 21′, 21″ which are substantially parallel to each other and to the plane of symmetry π and may be associated to appropriate fastening means, not shown, for connection to the support frame.

FIG. 7 also shows a human body support seat 3 according to the invention, which is designed for removable connection to a movable or stationary support frame, i.e. a saddle to be attached to a bicycle frame.

The seat 3 has a resilient upper layer 22 for elastically supporting a user's weight, with an underlying stiffening shell 2 attached thereto.

The upper layer 22 may in turn comprise an upper cover for containing a further resilient layer made of a material selected from polyurethane gels, foams, or the like.

A bracket 4 as described hereinbefore is placed underneath the layer 22, to be connected to the support frame by suitable external fastening means.

The above description clearly shows that the assembly 1 of the invention achieves the intended objects and particularly the object of providing a connection of a seat 3 to a support frame, which is characterized by high stability, and prevents any relative rotation between the bracket 4 and the shell 2 of the seat 3.

Thanks to the particular configuration of the bracket 4 and the connection receptacles 11′, 11″, the assembly 1 will impart a high aesthetic quality to the whole seat 3 in which it is used.

The quick-mount assembly, the bracket and the seat of this invention are susceptible to a number of changes and variants, within the inventive principle disclosed in the appended claims. All the details thereof may be replaced by other technically equivalent parts, and the materials may vary depending on different needs, without departure from the scope of the invention.

While the assembly, the bracket and the seat have been described with particular reference to the accompanying figures, the numerals referred to in the disclosure and claims are only used for the sake of a better intelligibility of the invention and shall not be intended to limit the claimed scope in any manner.

The instant application is based upon and claims priority of patent application no. VI2005A000322, filed on Feb. 12, 2005 in Italy, the disclosure of which is hereby expressly incorporated here in reference thereto.

1. A mounting assembly for stable attachment of a seat having a stiffening shell to a movable or stationary support frame, comprising:
a bracket which is substantially symmetric with respect to a longitudinal plane substantially perpendicular to the seat, said bracket comprising,
a pair of side rods having front end portions; and
rear end portions each designed for connection to the front part and the rear part of said shell,
wherein said rear end portions of said rods have a widened shape, defining respective male anti-rotation members, which are designed to be longitudinally slid into respective complementary first female receptacles rigidly associated to said shell, so to prevent any relative rotation between said bracket and said shells about a longitudinal axis, and to stabilize connection to the support frame.

2. The assembly as claimed in claim 1, wherein said widened rear end portions are formed of respective curved end sections lying on predetermined development planes.

3. The assembly as claimed in claim 2, wherein said development planes are substantially parallel and coincident.

4. The assembly as claimed in claim 2, wherein said development planes are symmetrically inclined with respect to said longitudinal plane of symmetry.

5. The assembly as claimed in claim 2, wherein the angle of curvature of said curved end sections is of 10° to 180°.

6. The assembly as claimed in claim 5, wherein said rear end portions substantially have a U-shape as seen in a plan view of said rear end portions.

7. The assembly as claimed in claim 1, wherein said rods have a substantially circular cross section.

8. The assembly as claimed in claim 1, wherein said rods are appropriately shaped and joined at their front end portions.

9. The assembly as claimed in claim 1, wherein said rods have central portions which are substantially parallel to each other and to said longitudinal plane of symmetry for fastening to said support frame.

10. The assembly as claimed in claim 1, wherein the front end portions of said rods are monolithic and configured to be fitted into a complementary second female receptacle couplable to said shell.

11. The assembly as claimed in claim 1, wherein said first female receptacles comprise elongate longitudinal cavities formed in substantially prismatic elements having at least one open front end for receiving respective male anti-rotation members sliding therein.

12. The assembly as claimed in claim 11, wherein said substantially prismatic elements taper towards the rear end of said shell.

13. (canceled)

14. The assembly as claimed in claim 1, wherein said first and second female receptacles are integral with said shell

15. A bracket for use in the mounting assembly claimed in claim 1 for stable attachment of a seat having a stiffening shell to a movable or stationary support frame, comprising
a pair of side rods having front end portions designed for connection to the front part of said shell; and
rear end portions designed for connection to the rear part of said shell,
wherein said rear end portions of said rods have a widened shape, defining respective male anti-rotation members, which are designed to be longitudinally slid into respective complementary first female receptacles rigidly associated to said shell, so to prevent any relative rotation between said bracket and said shell about a longitudinal axis.

16. A human body support seat, designed to be removably connected to a movable or stationary frame, comprising:
a resilient upper layer designed to elastically support a user's weight;
a stiffening shell connected to the underside of said upper layer;
a lower bracket couplable to a movable or stationary support frame by appropriate fastening means,
wherein said bracket comprises a pair of side rods having front end portions designed for connection to the front part of said shell and rear end portions each designed for connection to the rear part of said shell, and
wherein said rear end portions of said rods have a widened shape, defining respective male anti-rotation members, which are designed to be longitudinally slid into respective complementary first female receptacles rigidly associated to said shell, so as to prevent any relative rotation between said bracket and said shell about a longitudinal axis.
